(19) United States
(12) Patent Application Publication
(10) Pub. No.: US 2014/0351700 A1
(43) Pub. Date: Nov. 27, 2014

(54) APPARATUSES AND METHODS FOR RESOURCE REPLACEMENT

(71) Applicant: Tencent Technology (Shenzhen) Company Limited, Shenzhen (CN)

(72) Inventors: Cheng FENG, Shenzhen (CN); Bo HU, Shenzhen (CN); Xi WANG, Shenzhen (CN); Ruiyi ZHOU, Shenzhen (CN); Zhipei WANG, Shenzhen (CN); Kai ZHANG, Shenzhen (CN); Xin QING, Shenzhen (CN); Huijiao YANG, Shenzhen (CN); Ying HUANG, Shenzhen (CN); Yulei LIU, Shenzhen (CN); Wei LI, Shenzhen (CN); Zhengkai XIE, Shenzhen (CN)

(73) Assignee: Tencent Technology (Shenzhen) Company Limited, Shenzhen (CN)

(21) Appl. No.: 14/454,191

(22) Filed: Aug. 7, 2014

Related U.S. Application Data
(63) Continuation of application No. PCT/CN2013/090116, filed on Dec. 20, 2013.

(30) Foreign Application Priority Data
May 9, 2013 (CN) 201310169172.7

(51) Int. Cl. G06F 3/16; G06F 3/01

(52) U.S. Cl. CPC G06F 3/167; G06F 3/016
USPC 715/702; 715/728

(57) ABSTRACT

An apparatus may comprise at least one processor-readable non-statutory storage medium and at least one processor in communication with the at least one storage medium. The at least one medium may comprise at least one set of instructions for changing an audio-visual effect of a user interface on the apparatus. The at least one processor may be configured to execute the at least one set of instructions to obtain operating data associated with at least one of an acceleration input and acoustic input from a sensor of the terminal device; determine whether the operating data meet a preset condition; and replace a current audio-visual effect of a user interface (UI) with a selected audio-visual effect when the operating data meet the preset conditions.

### PRIORITY STATEMENT

This application is a continuation of International Application No. PCT/CN2013/090116, filed on Dec. 20, 2013, in the State Intellectual Property Office of the People's Republic of China, which claims the priority benefit of Chinese Patent Application No. 201310169172.7 filed on May 9, 2013, the disclosures of which are incorporated herein in their entirety by reference.

### TECHNICAL FIELD

The present disclosure relates to field of computer technology. Specifically, the present disclosure relates to resource replacement methods and apparatuses.

### BACKGROUND

Users of intelligent terminal devices (e.g., smart phones) today have higher requirements to performance of Graphical User Interfaces (GUI) of an application than before. For example, users of an application of a smart phone may want to change skin pattern of its GUI from time to time. To meet personalized demands of the users in terminal devices, generally multiple GUI resources need to be preset in an application for the users to choose. Such GUI resources may be skin resources and/or background picture resources to be displayed on the GUI. The users may replace the resource of the application based on their personal preferences.

To replace a resource, such as replacing skin of a GUI, a terminal device generally first receives a trigger signal acting on a logo or text, and then shows to the user two or more existing resources in the terminal device based on the trigger signal. The terminal device receives the selection signal when the user selects one resource, and accordingly replaces the current resource used in the GUI with the corresponding resource of the selection signal. Generally, both of the trigger signal and the selection signal are generated when the user clicks the touch screen or keyboard with hand.

When the above resource replacement method is used for resource replacement, the user needs to click the touch screen or keyboard with hand to generate the trigger signal, which easily incurs touch screen or keyboard dissipation and reduces the service life of the terminal device.

### SUMMARY

According to an aspect of the present disclosure, a processor-implemented method for changing an audio-visual effect of a user interface on a terminal device may be executed by at least one processor. The method may comprise obtaining operating data associated with at least one of an acceleration input and acoustic input from a sensor of the terminal device; determining whether the operating data meet a preset condition; and replacing a current audio-visual effect of a user interface (UI) with a selected audio-visual effect when the operating data meet the preset conditions.

According to an aspect of the present disclosure, an apparatus may comprise at least one processor-readable non-statutory storage medium and at least one processor in communication with the at least one storage medium. The at least one medium may comprise at least one set of instructions for changing an audio-visual effect of a user interface on the apparatus. The at least one processor may be configured to execute the at least one set of instructions to obtain operating data associated with at least one of an acceleration input and acoustic input from a sensor of the terminal device; determine whether the operating data meet a preset condition; and replace a current audio-visual effect of a user interface (UI) with a selected audio-visual effect when the operating data meet the preset conditions.

According to an aspect of the present disclosure, a processor-readable non-statutory storage medium may comprise at least one set of instructions for changing an audio-visual effect of a user interface on a terminal device. The at least one set of instructions may be configured to direct at least one processor to perform acts of obtaining operating data associated with at least one of an acceleration input and acoustic input from a sensor of the terminal device; determining whether the operating data meet a preset condition; and replacing a current audio-visual effect of a user interface (UI) with a selected audio-visual effect when the operating data meet the preset conditions.

### DESCRIPTIONS OF THE DRAWINGS

The above and other features and advantages will become more apparent by describing in detail example embodiments thereof with reference to the attached drawings in which:

FIG. 1 illustrates a flowchart of a method for GUI resource replacement according to example embodiments of the present disclosure;

FIG. 2 illustrates a flowchart of a method for the GUI resource replacement according to the example embodiments of the present disclosure;

FIG. 3 illustrates a coordinate system on a terminal device according to the example embodiments of the present disclosure;

FIG. 4 illustrates a flowchart of a method for the GUI resource replacement according to the example embodiments of the present disclosure;

FIG. 5 is a schematic diagram illustrating a structure of a GUI resource replacement apparatus according to the example embodiments of the present disclosure;

FIG. 6 is a schematic diagram illustrating a structure of a GUI resource replacement apparatus according to the example embodiments of the present disclosure; and

FIG. 7 is a schematic diagram illustrating an example embodiment of a terminal device that may be a terminal device as introduced in the present disclosure.

### DETAILED DESCRIPTION OF THE INVENTION

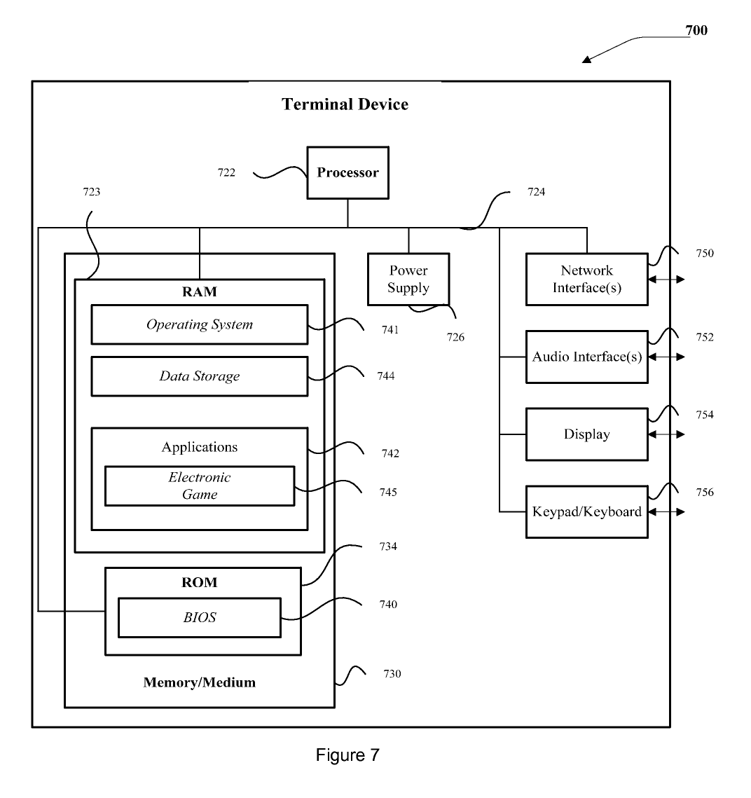

FIG. 7 is a schematic diagram illustrating an example embodiment of a terminal device as introduced in the present disclosure. The terminal device may include apparatuses to execute methods and software systems introduced in the present disclosure. A terminal device 700 may be a computing device capable of executing a software system. The terminal device 700 may, for example, be a device such as a personal desktop computer or a portable device, such as a laptop computer, a tablet computer, a cellular telephone, or a smart phone.

The terminal device 700 may vary in terms of capabilities or features. Claimed subject matter may be intended to cover a wide range of potential variations. For example, the terminal device 700 may include a keypad/keyboard 756. It may also include a display 754, such as a liquid crystal display (LCD), or a display with a high degree of functionality, such as a touch-sensitive color 2D or 3D display. In contrast, however, as another example, a web-enabled terminal device 700 may include one or more physical or virtual keyboards, and mass storage medium 730.

The terminal device 700 may also include or may execute a variety of operating systems 741, comprising an operating system, such as a Windows™ or Linux™, or a mobile operating system, such as iOS™, Android™, or Windows Mobile™. The terminal device 700 may include or may execute a variety of possible applications 742, such as an electronic game 745. An application 742 may enable communication with other devices via a network, such as communicating with another computer or a server via a network.

Further, the terminal device 700 may include one or more non-transitory processor-readable storage media 730 and one or more processors 722 in communication with the non-transitory processor-readable storage media 730. For example, the non-transitory processor-readable storage media 730 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 730 may store sets of instructions, or units and/or modules that include the sets of instructions, for conducting operations and/or method steps described in the present disclosure. Alternatively, the units and/or modules may be hardware disposed in the terminal device 700 configured to conduct operations and/or method steps described in the present disclosure. The one or more processors may be configured to execute the sets of instructions and perform the operations in example embodiments of the present disclosure.

Merely for illustration, only one processor will be described in terminal devices that execute operations and/or method steps in the following example embodiments. However, it should be note that the terminal devices in the present disclosure may also include multiple processors, thus operations and/or method steps that may be performed by one processor as described in the present disclosure may also be jointly or separately performed by the multiple processors. For example, if in the present disclosure a processor of a terminal device executes both step A and step B, it should be understood that step A and step B may also be performed by two different processors jointly or separately in the terminal device (e.g., the first processor executes step A and the second processor executes step B, or the first and second processors jointly execute steps A and B).

The following resource replacement methods may be applied in the terminal device 700 and may be implemented as an intelligent TV, a smart phone, a tablet, or any other implementation as mentioned above and may be perceived by one of ordinary skill in the art at the time of the filing of the present disclosure. The resource replacement may be change of skin, color, background picture, layout, background music, and/or any audio or visual effect and/or property of a user interface (UI) displaying on a screen of the terminal device.

FIG. 1 illustrates a flowchart of a method for resource replacement according to example embodiments of the present disclosure. The resource replacement method may include having the terminal device (e.g., the processor of the terminal device) to perform the following acts:

Step 101, obtain the operating data of the terminal device, wherein the operating data may be shake data and/or air blow data;

In the embodiment, the operating data (e.g., operating signal) may be the data generated when performing relevant operations on the terminal device. For example, the shake data may be data generated when a user shakes the terminal device, or more generally, when the terminal device is under a predefined kinematic motion (e.g., when the terminal is under acceleration or deceleration); and the air blow data may be data generated when a user blows air onto the terminal device (e.g., blowing air to a microphone of the terminal device), or alternatively, when the user speaks a particular instruction (i.e., audio signal) to the terminal device.

Step 102, detecting whether or not the operating data meet preset conditions, and if the operating data that meet the preset conditions, the terminal device may execute Step 103;

The preset conditions may be configured to make sure that the operating data received by the terminal device are not misoperation or unintentional operation from a user. In Step 102, the operating data may be detected as to whether or not they meet the preset conditions. If the operating data meet the preset conditions, the terminal device may determine that the operating data are not generated by misoperation, and may execute Step 103 accordingly; if the operating data do not meet the preset conditions, the terminal device may determine that the operating data are generated by misoperation, thus may not execute Step 103.

Step 103, replacing the current GUI resource in the application.

The current GUI resource may be a GUI resource being currently used by the application; the GUI resource may be the skin, background picture, color, layout, background music, or any other audio and/or visual effect and/or property of the application that one of the skilled in the art would have perceived at the time of the filing of the present application.

Thus, according to the example embodiments of the present disclosure, a method of resource replacement may include having a terminal device obtaining the operating data, wherein the operating data may be the shake data and/or the air blow data, detecting whether or not the operating data meet the preset conditions; and replacing the current GUI resource in the application if the operating data meet the preset conditions. The resource replacement method may avoid screen or keyboard energy dissipation that may reduce the service life of the terminal device resulting from the trigger signals generated when the user clicks the touch screen or keyboard with hand, and may enhance the service life of the terminal device.

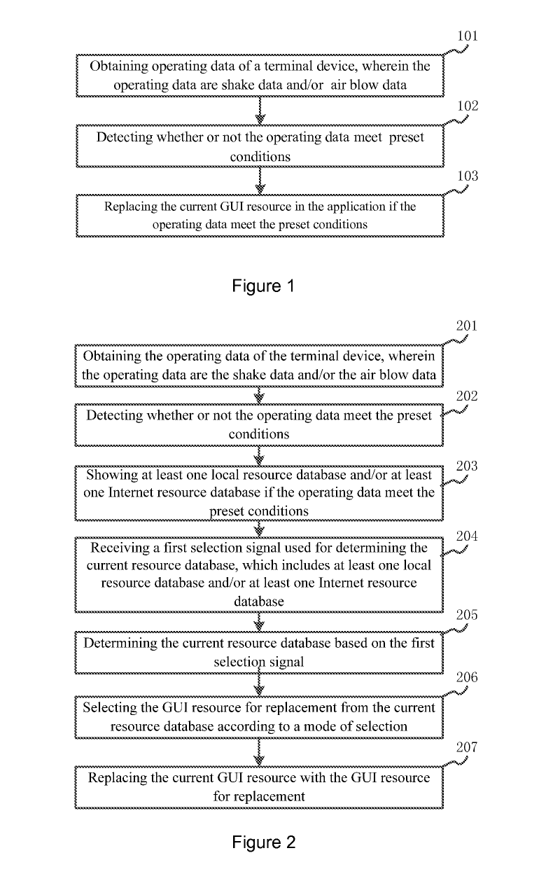

FIG. 2 illustrates a flowchart of a method for the GUI resource replacement according to the example embodiments of the present disclosure. The resource replacement method may include having the terminal device (e.g., the processor of the terminal device) to perform the following acts:

Step 201, obtaining the operating data of the terminal device, wherein the operating data may be the shake data and/or the air blow data;

The operation of obtaining the operation data may be triggered by a command from a user of the terminal device. For example, the user may click a hotkey on a keyboard of the terminal device to instruct the terminal device to receive the operation data. Alternatively, the user may click a button on an interface of the terminal device to instruct the terminal device to receive the operation data. The operating data may be the data generated when performing relevant operations on the terminal device. For example, the shake data may be generated when shaking the terminal device and the air blow data may be generated when blowing air onto the terminal device.

If the operation data are the shake data, the obtaining of the operating data of the terminal device may include: obtaining an acceleration data of the terminal device within a first preset time period through a sensor in the terminal device, and treating the acceleration data as the shake data if the acceleration data satisfy the preset conditions for shake data.

When a user shakes the terminal device, acceleration will be generated in the shaking direction of the terminal device, and the acceleration data may be measured by the terminal device. The acceleration may be treated as the shake data if the acceleration data meet the present conditions. For example, the acceleration data may be generated by a sensor preset in the terminal device; the sensor may be an inductive gravity accelerometer, and/or may be other types of sensors that one of ordinary skill in the art would have perceived at the time of the filing of the present application.

If the operating data are the air blow data, the obtaining of the operating data of the terminal device may include: obtaining a sound signal of the terminal device within a second preset time period through a microphone of the terminal device, and treating the sound signal as the air blow data if the sound signal meets the preset conditions for the blow data;

Because blowing the air into the microphone of the terminal device may generate a sound signal of certain frequency, the frequency may be measured and recognized by the terminal device, and the sound signal may be treated as the air blow signal. The sound signal may be obtained through a microphone preset in the terminal device. Alternatively, the sound signal may also be obtained through other equipment that one of ordinary skill in the art would have perceived at the time of the filing of the present application.

Step 202, detecting whether or not the operating data meet the preset conditions. If the detection result meets the preset conditions, the terminal device may execute Step 203;

To this end, the method may require the operating data to meet a preset condition in order to avoid response to data generated by misoperation, and the operating data may be detected as to whether or not they meet the preset conditions. If the operating data meet the preset conditions, the terminal device may determine that the operating data are not generated by misoperation. The terminal device may execute Step 203 accordingly. If the operating data do not meet the preset conditions, the terminal device may determine that the operating data are generated by misoperation, and do not execute Step 203 accordingly.

For example, if the operating data are the shake data and the shake data are obtained from acceleration, the operating data may be detected as to whether or not they meet the preset conditions, which may include: within the first preset time period, detecting whether or not the absolute value of certain component of the shake data in at least one axial direction continues to exceed the threshold value corresponding to the axial direction. If the detection result shows that the absolute value of the component of the shake data in at least one axial direction continues to exceed the threshold value corresponding to the axial direction, the terminal device may determine that the operating data meet the first preset conditions. For example, the terminal device may the operating data 9 times in a time period of 800 ms (the terminal device samples the operating data every 100 ms). If the operating data exceed the threshold value every time, the terminal device may determine that the operating data meet the first preset conditions.

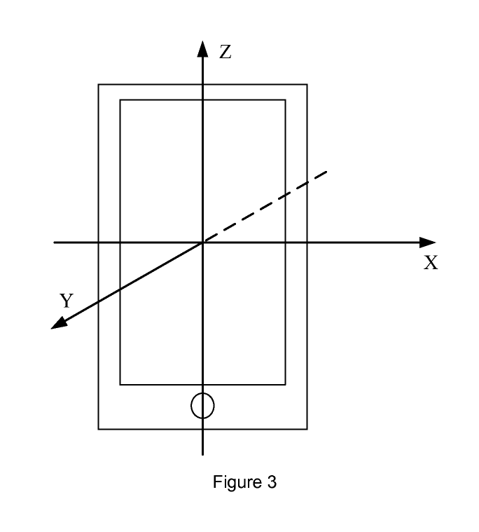

Measuring the acceleration data may be based on three coordinate axes. The three coordinate axis may be three sensing axis of the sensor. For example, the directions of the three sensing axis may respectively correspond to the length, width and height of the terminal device. FIG. 3 is a schematic diagram illustrating a terminal device coordinate system according to the example embodiments of the present disclosure. The terminal device coordinate system may be established by setting the terminal device screen as the x-z plane, wherein the center of the terminal device may be the origin of coordinate. According to the coordinate system, if the screen of the terminal device is positioned toward a user, the positive semi-axis of the x axis may point to the right side of the user, and the positive semi-axis of the z axis may point upwards. The y axis may be perpendicular to the x axis and z axis on the terminal device plane. The positive semi-axis may point towards the user, following the right-hand rule.

After the sensor measures the acceleration data, the acceleration data may be decomposed along the directions of the x axis, the y axis, and the z axis. The corresponding components of the acceleration data may be aₓ, a_{y}, and a_{z} respectively. The method may require the terminal device to set acceleration threshold values aₓ₀, a_{y0} and a_{z0} on the x axis, the y axis and the z axis respectively. aₓ₀, a_{y0} and a_{z0} may be the same or may be different. The terminal device may determine whether the absolute value of ax is larger than aₓ₀. If yes, the terminal device may determine that the absolute value of the acceleration component aₓ in the x axis direction of the acceleration exceeds the threshold value aₓ₀ corresponding to the x axis direction. In like manner, the terminal device may determine whether or not the absolute value of the acceleration component a_{y} in the y axis direction of the acceleration exceeds the threshold value a_{y0} corresponding to the y axis direction, and whether or not the absolute value of the acceleration component a_{z} in the z axis direction of the acceleration exceeds the threshold value a_{z0} corresponding to the z axis direction. If the absolute value of the component of the shake data in at least one axial direction exceeds the threshold value corresponding to the axial direction, the terminal device may determine that the operating data meet the first preset conditions.

Further, to avoid responding to the operating data generated by misoperation, the absolute value of the component of the shake data in at least one axial direction may be detected within the first preset time period as to whether or not it continues to exceed the threshold value corresponding to the axial direction, and if yes, the terminal device may determine that the operating data meet the preset conditions.

If the operating data are the air blow data and the obtained air blow data are from a sound signal, because the sound signal from blowing air into the microphone of the terminal device has a certain frequency, the terminal device may detect and measure the frequency of the sound signal and determine whether or not the sound signal meets the second preset conditions. For example, the determination of whether or not the operating data meet the second preset conditions may include: within the second preset time period, detecting the number of times that the peak value of the air blow data exceeds a preset peak value, and determining whether the number of times exceeds the first threshold value. If the number of times exceeds a first threshold value, the terminal device may determine that the operating data meet the preset conditions. Alternatively, within the second preset time period, the terminal device may detect whether or not the mean value of the peak value of the air blow data exceeds a second threshold value. If the mean value of the peak value of the air blow data exceeds the second threshold value, the terminal device may determine that the operating data meet the preset conditions.

Step 203, displaying to a user at least one local resource database and/or at least one Internet resource database (e.g., showing on the screen of the terminal device what options of skins a user may have). Each of the plurality of local databases and the Internet databases comprises a plurality of audio-visual effects of the UI on a screen of the terminal device.

After confirming the operation data, the terminal device may display options of the GUI resources to a user. For example, the terminal device may show on the screen of the terminal device various of skin for the GUI a user may choose. To expand the range of selection for the GUI resource for replacement, the GUI resource for replacement may also be selected from an Internet resource database. Downloading the GUI resource for replacement from the Internet resource database may consume large amount of data traffic of the terminal device. To increase the friendliness of the terminal device, the user may be reminded to confirm the current resource database before selecting the GUI resource for replacement.

To show the options of GUI resources to the user, at least one local resource database and/or at least one Internet resource database may be shown on the terminal device interface, so that the user may be able to choose the current resource database from the local resource database and/or the Internet resource database, and thus select the GUI resource from the current resource database, wherein, the local resource database may be the resource database downloaded in advance, and may also be the resource database formed by pictures taken by a camera of the terminal device or a pictures uploaded to the terminal device. The source of the pictures in the local resource database is not limited by the example embodiments.

Step 204, receiving a first selection signal used for determining the current resource database, wherein the current resource database may include at least one local resource database and/or at least one Internet resource database;

In this step, the first selection signal may be a confirmation signal received from the user to select the current resource database. The terminal device may receive the first selection signal, and determine the current resource database based on the first selection signal. The first selection signal may be generated when the user clicks the touch screen or keyboard with hand, or may be generated after the user obtains the operating data and detects that the operating data meet the preset conditions, which is not limited by the example embodiments of the present disclosure.

Step 205, determining the current resource database based on the first selection signal;

In this step, the terminal device may identify the current resource database in at least one local resource database and/or Internet resource database based on the first selection signal, so as to choose the GUI resource for replacement from the current resource database.

Step 206, selecting the GUI resource for replacement from the current resource database according to a preset selection mode of the terminal device;

After the terminal device identifies the current resource database, it may choose the GUI resource for replacement from the current resource database according to the preset selection mode of the terminal device. The preset selection mode of the terminal device may include a default selection mode, a random selection mode, a selection mode based on frequency-of-use, a selection mode based on number-of-recommendations, or any combinations thereof.

The default selection mode of the terminal device may be a mode for selecting default GUI resource from the current resource database as the GUI resource for replacement. The default GUI resource may be preset and modified by the terminal device. For example, the terminal device may preset a default GUI resource in the current resource database, and after the current resource database is identified, the default GUI resource may be directly treated as the GUI resource for replacement.

The random selection mode of the terminal device may be a mode for random selecting of a GUI resource from the current resource database as the GUI resource for replacement. The random selection method may be preset and modified by the terminal device. For example, after the terminal device identifies the current resource database, it may choose in a GUI resource randomly as the GUI resource for replacement through the preset random selecting method.

The frequency-of-use selection mode may be a mode for selecting a GUI resource as the GUI resource for replacement based on the frequency for use of the GUI resource. The selection rules may be set up and modified by the terminal device. For example, the terminal device may obtain the total frequency of use for each GUI resource in the current resource database, and treat the GUI resource of the highest total frequency of use as the GUI resource for replacement. Alternatively, the terminal device may obtain the frequency of use for each GUI resource within a preset time period, and treat the GUI resource of the highest frequency of use within the preset time period as the GUI resource for replacement.

The number-of-recommendations selection mode of the terminal device may be a mode for selecting a GUI resource as the GUI resource for replacement based on the number of times by which a GUI resource is recommended by users thereof. The selection rules may be set up and modified by the terminal device. For example, the terminal device may obtain the total number of recommendations for each GUI resource in the current resource database, and treat the GUI resource with the highest total number of recommendations as the GUI resource for replacement. Alternatively, the terminal device may obtain the number of recommendations for each GUI resource within a preset time period, and treat the GUI resource with the highest number of recommendations as the GUI resource for replacement.

Step 207, replacing the current GUI resource with the GUI resource for replacement.

If the GUI resource for replacement is the GUI resource in the local resource database, the current GUI resource may be substituted with the GUI resource for replacement; if the resource for replacement is the GUI resource in the Internet resource database, the terminal device may first download the GUI resource for replacement and then substitute the current GUI resources with the downloaded GUI resource for replacement.

Accordingly, the above method may include having the terminal device to perform the following acts: obtaining the operating data of the terminal device, wherein the operating data may be the shake data and/or the air blow data; detecting whether or not the operating data meet the preset conditions; replacing the current graphical user interface GUI resource in the application if the detection result meet the preset conditions. In addition, the above method may include showing at least one local resource database and/or at least one Internet resource database to a user of the terminal device; receiving the first selection signal used for determining the current resource database; and determining the current resource database based on the first selection signal for selecting the GUI resource for replacement in the current resource database per the preset selection mode of the terminal device.

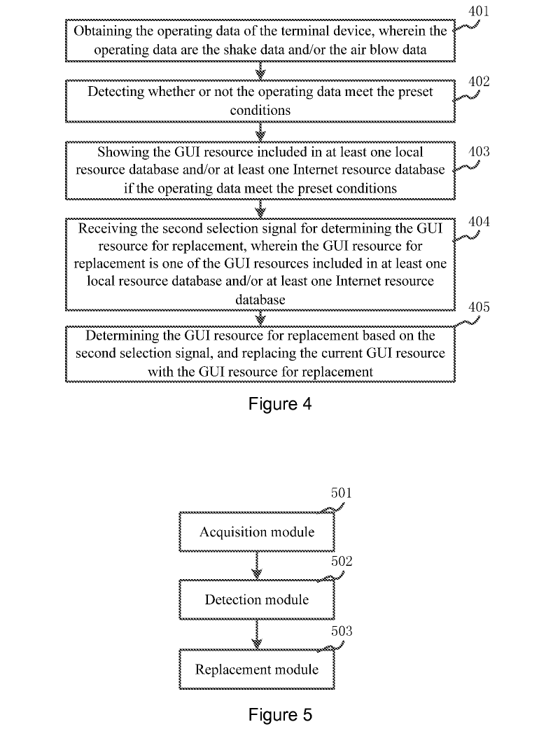

FIG. 4 illustrates a flowchart of a method for the resource replacement according to the example embodiments of the present disclosure. The resource replacement method may include having the terminal device (e.g., the processor of the terminal device) to perform the following acts:

Step 401, obtaining the operating data of the terminal device, wherein the operating data may be the shake data and/or the air blow data;

The operating data may be the data generated when performing relevant operations on the terminal device. For example, the shake data may be data generated when shaking the terminal device; and the air blow data may be data generated when blowing air onto the terminal device.

If the operating data are the shake data, the obtaining of the operating data of the terminal device may include: obtaining the acceleration of the terminal device within the first preset time period through a sensor, and treating the acceleration as the shake data. If the operating data are the air blow data, the obtaining of the operating data of the terminal device may include: obtaining the sound signal of the terminal device within the second preset time period through a microphone, and treating the sound signal as the air blow data. Details of obtaining the shake data and/or air blow data have been introduced in Step 201.

Step 402, detecting whether or not the operating data meet the preset conditions, and if the detection result meet the preset conditions, the terminal device may execute Step 403;

The terminal device may preset conditions to obtain the operating data in order to avoid response to the operating data generated by misoperation. If the operating data meet the preset conditions, the terminal device may determine that the operating data are not generated by misoperation, then the terminal device may execute Step 403; if the operating data do not meet the preset conditions, the terminal device may determine that the operating data may be generated by misoperation, and the terminal device may stop executing 403.

If the operating data are the shake data and the obtained shake data re from acceleration, the operating data may be detected as to whether or not they meet the preset conditions, which may include the following: within the first preset time period, detecting whether or not the absolute value of the component of the shake data in at least one axial direction continues to exceed the threshold value corresponding to the axial direction. If the absolute value of the component of the shake data in at least one axial direction continues to exceed the threshold value corresponding to the axial direction, the terminal device may determine that the operating data meet the preset conditions.

If the operating data are the air blow data from a sound signal, the operating data may be detected as to whether or not they meet the preset conditions, which may include: within the second preset time period, detecting the number of times by which the peak value of the air blow data exceeds the preset peak value. If the number exceeds the first threshold value, the terminal device may determine that the operating data meet the preset conditions. Alternatively, within the second preset time period, the terminal device may detect whether or not the mean value of the peak value of the air blow data exceeds the second threshold value. If the mean value of the peak value of the air blow data exceeds the second threshold value, the terminal device may determine that the operating data meet the preset conditions.

Detailed description of detecting whether or not the operating data meet the preset conditions has been described in Step 202.

Step 403, showing the GUI resource included in at least one local resource database and/or at least one Internet resource database;

If the identification of the GUI resource is to find the name of the GUI resource from a list of options in the form of text or chart, it may be difficult for the user to identify the right GUI resources conveniently. To avoid misoperation resulting from this problem, after detecting that the operating data meet the preset conditions, the terminal device may display and/or show the GUI resource that includes at least one local resource database and/or at least one Internet resource database, so that the user may choose the GUI resource for replacement from the displayed GUI resource, thus enhanced accuracy for resource replacement.

Step 404, which may be to receive the second selection signal used for determining the GUI resource for replacement, wherein the GUI resource for replacement may be one of the GUI resources included in at least one local resource database and/or at least one Internet resource database;

The terminal device may receive the second selection signal, and determine the GUI resource for replacement based on the second selection signal, wherein the second selection signal may be generated by the user when the user clicks the touch screen or keyboard, or may be generated after the terminal device obtains the operating data and detects that the operating data meet the preset conditions. For example, in order to change a background picture of an application, the user may initiate the background change by actively select a GUI resource for replacement. Or alternatively, the user may do the selection when the terminal device provides a plurality of selection options to the user after a shake operation.

Step 405, determining the GUI resource for replacement based on the second selection signal, and replacing the current GUI resource with the GUI resource for replacement.

If the GUI resource for replacement is the GUI resource in the local resource database, the current GUI resource may be substituted with the GUI resource for replacement; if the resource for replacement may be the GUI resource in the Internet resource database, the GUI resource for replacement may be downloaded first and then the terminal device may substitute the current GUI resource with the downloaded GUI resource for replacement.

Accordingly, the above method may include having the terminal device to perform the following acts: obtaining the operating data of the terminal device, wherein the operating data may be the shake data and/or the air blow data; detecting whether or not the operating data meet the preset conditions; replacing the current graphical user interface GUI resource in the application if the operating data meet the preset conditions. In addition, the above method may also include having the terminal device to perform the following acts: displaying to the user of the terminal device the GUI resource, including at least one local resource database and/or at least one Internet resource database; receiving the second selection signal used for determining the GUI resource for replacement; determining the GUI resource for replacement based on the second selection signal, and replacing the current GUI resource with the GUI resource for replacement.

FIG. 5 is a schematic diagram illustrating a structure of a resource replacement apparatus according to the example embodiments of the present disclosure. The resource replacement apparatus may be implemented as the terminal device 700 in FIG. 7, such as an intelligent TV, a smart phone, or a tablet, etc. The resource replacement apparatus may include: an acquisition module 501 configured to obtain the operating data of the terminal device, wherein the operating data may be the shake data and/or the air blow data; a detection module 502 configured to detect whether or not the operating data as obtained by the acquisition module 501 meet the preset conditions; and a replacement module 503 configured to replace the current graphical user interface GUI resource in the application if the operating data meet the preset conditions.

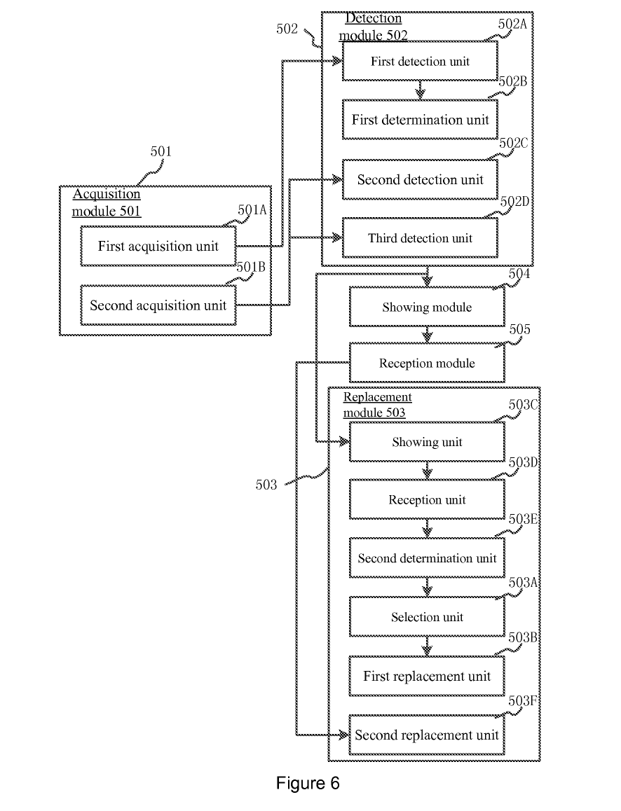

FIG. 6 is a schematic diagram illustrating a structure of a resource replacement apparatus according to the example embodiments of the present disclosure. The resource replacement apparatus may be implemented as the terminal device 700, such as an intelligent TV, a smart phone or a tablet, etc. The resource replacement apparatus may include: an acquisition module 501, a detection module 502, and a replacement module 503.

The acquisition module 501 may be configured to obtain the operating data of the terminal device, wherein the operating data may be the shake data and/or the air blow data;

The detection module 502 may be configured to detect whether or not the operating data as obtained by the acquisition module 501 meet the preset conditions.

The replacement module 503 may be configured to replace the current GUI resource in the application if the detection result of the detection module 502 is that the operating data meet the preset conditions.

Further, if the operating data are the shake data, the acquisition module 501 may include a first acquisition unit 501A being configured to obtain the acceleration data of the terminal device within the first preset time period through a sensor, and treating the acceleration as the shake data.

Accordingly, the detection module 502 may include a first detection unit 502A configured to detect within the first preset time period whether or not the absolute value of the component of the shake data in at least one axial direction as obtained by the first acquisition unit continues to exceed the threshold value corresponding to the axial direction.

The detection module 502 may also include a first determination unit 502B, configured to determining that the operating data meet the preset conditions if the detection result of the first detection unit 502A shows that the absolute value of the component of the shake data in at least one axial direction continues to exceed the value corresponding to the axial direction.

Further, if the operating data are the air blow data, the acquisition module 501 may include: a second acquisition unit 501B, configured to obtain the sound signal of the terminal device within the second preset time period through a microphone, and treating the sound signal as the air blow data.

Accordingly, the detection module 502 may include a second detection unit 502C, configured to detect within the second preset time period whether or not the number of times by which the peak value of the air blow data obtained by the second acquisition unit 501B exceeds the preset peak value exceeds the first threshold value. If the number of times by which the peak value of the air blow data exceeds the preset peak value exceeds the first threshold value, the operating data may be determined to meet the preset conditions.

Alternatively, the detection module 502 may include a third detection unit 502D, configured to detect within the second preset time period whether or not the mean value of the peak value of the air blow data obtained by the second acquisition unit 501B exceeds the second threshold value, and if the mean value of the peak value of the air blow data exceeds the second threshold value, the operating data may be determined to meet the preset conditions.

Further, the replacement module 503 may include a selection unit 503A, configured to select the GUI resource for replacement from the current resource database per the preset selection mode of the terminal device; and a first replacement unit 503B, configured to replace the current GUI resource with the GUI resource for replacement selected by the selection unit 503A. The preset selection mode of the terminal device may include at least one of the default selection mode, the random selection mode, the frequency-of-use selection mode, and the number-of-recommendations selection mode of the terminal device.

Further, the replacement module 503 may also include a showing unit 503C, configured to show and/or display to the user at least one local resource database and/or at least one Internet resource database on the screen of the terminal device before the selection unit 503A selects the GUI resource for replacement from the current resource database per the preset selection mode of the terminal device; a reception unit 503D, configured to receive the first selection signal used for determining the current resource database, wherein the current resource database may include at least one local resource database and/or at least one Internet resource database as shown by the showing unit 503C; and a second determination unit 503E, configured to determining the current resource database based on the first selection signal as received by the reception unit 503D.

Further, the apparatus may also include a showing module 504, configured to show to the user the GUI resource included in at least one local resource database and/or at least one Internet resource database before the replacement module 503 replaces the current GUI resource in the application; a reception module 505, configured to receive the second selection signal used for determining the GUI resource for replacement, wherein the GUI resource for replacement may be one of the GUI resources included in at least one local resource database and/or at least one Internet resource database as shown by the showing module 504.

Accordingly, the replacement module 503 may include a second replacement unit 503F, configured to determine the GUI resource for replacement based on the second selection signal as received by the reception module 505, and replace the current GUI resource with the GUI resource for replacement.

Accordingly, the resource replacement apparatus may be configured to obtain the operating data of the terminal device, wherein the operating data may be the shake data and/or the air blow data; detect whether or not the operating data meet the preset conditions; replace the current graphical user interface GUI resource in the application if the operating data meet the preset conditions. In addition, the resource replacement apparatus may be further configured to show and/or display at least one local resource database and/or at least one Internet resource database; receive the first selection signal used for determining the current resource database; determine the current resource database based on the first selection signal for selecting the GUI resource for replacement in the current resource database per the preset selection mode of the terminal device. Therefore, the resource replacement apparatus may provide variety of selections for selecting the GUI resource for replacement from the local resource database, and expand the range of selection for the GUI resource for replacement.

When the resource replacement apparatuses as provided by the example embodiments are implemented in resource replacement, examples and descriptions may be presented only on the basis of the division of the aforesaid various functional modules. In practical application, the aforesaid functions and/or modules may be assigned to different functional modules for completion based on needs, i.e., the internal structure of the resource replacement apparatus may be divided into different functional modules so as to complete all or some of the functions as described above.

The interactions and execution processes among various modules/units of the aforementioned apparatus may be based on the same concept as the example embodiments of the methods in the present disclosure and the technical effects they bring forth may be the same as those of the example embodiments of the methods in the present disclosure. Those of ordinary skill in the art may understand that all or some of the steps in the various methods in the aforementioned embodiments may be completed through hardware or alternatively via programs, i.e., by executing the programs by corresponding hardware. Such programs may be stored in a computer-readable memory medium. The memory medium may include: Read Only Memory (ROM), Random Access Memory (RAM), a disk or CD.

The serial numbers of the aforesaid embodiments of the present disclosure may be only for purpose of description, and do not represent the superiority or inferiority of the embodiments.

While example embodiments of the present disclosure relate to apparatus and methods for replacing a GUI resources intelligent terminal, the apparatus and methods may also be applied to other Applications. For example, the methods and apparatus may be implemented in activating other applications, such as internet browsing, e-graph drawings, or e-games. The present disclosure intends to cover the broadest scope of apparatuses and methods for content pasting.

Thus, example embodiments illustrated in FIGS. 1-7 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A processor-implemented method for changing an audio-visual effect of a user interface on a terminal device, the method comprising:
obtaining, by a processor, operating data associated with at least one of an acceleration input and acoustic input from a sensor of the terminal device;
determining, by a processor, whether the operating data meet a preset condition; and
replacing, by a processor, a current audio-visual effect of a user interface (UI) with a selected audio-visual effect when the operating data meet the preset conditions.

2. The method of claim 1, wherein the acceleration input is generated when a user of the terminal device shakes the terminal device; and
the acoustic input is generated when the user of the terminal device blows air or speaks to a microphone of the terminal device.

3. The method of claim 1, wherein when the operating data are associated with the acceleration input, the preset condition comprises, within a first preset time period, that a component of the acceleration input along a direction in a space continues to exceed a threshold value.

4. The method of claim 1, wherein when the operating data are the acoustic input, the preset condition comprises at least one of:
that a peak value of the acoustic input exceeds a preset peak value for a number of times more than a first threshold value within a second preset time period; and
that a mean value of the peak value of the acoustic input exceeds a second threshold value within the second present time period.

5. The methods of any of claims 1 to 4, wherein the replacing of the current audio-visual effect of the UI comprises:
selecting an audio-visual effect of the UI from a current resource database under a preset selection mode of the terminal device; and
replacing the current audio-visual effect of the UI with the selected audio-visual effect of the UI;
wherein the preset selection mode of the terminal device comprises at least one of:
a default selection mode,
a random selection mode,
a selection mode configured to select an audio-visual effect of the UI based on frequency-of-use thereof, and
a selection mode configured to select an audio-visual effect of the UI based on number-of-recommendations thereof.

6. The method of claim 5, further comprising:
displaying, by a processor, at least one resource database,
wherein the at least one resource database comprises one or more local resource databases and Internet resource databases, and
wherein each of the one or more local databases and the Internet databases comprises a plurality of audio-visual effects of the UI;
receiving, by a processor, a first selection signal selecting a resource database from the at least one resource database; and
determining, by a processor, the selected resource database as the current resource database.

7. The method of any of claims 1 to 4, further comprising:
displaying, by a processor, a plurality of audio-visual effects from at least one resource database,
wherein the at least one resource database comprises one or more local resource databases and Internet resource databases, and
receiving, by a processor, a second selection signal selecting the selected audio-visual effect from the plurality of audio-visual effects; and
replacing, by a processor, the current audio-visual effect of the UI with the selected audio-visual effect after receiving the second selection signal.

8. An apparatus, comprising:
at least one processor-readable non-statutory storage medium comprising a plurality of module, wherein each module comprises at least one set of instructions for changing an audio-visual effect of a user interface on the apparatus; and
at least one processor in communication with the at least one storage medium configured to execute the at least one set of instructions to:
obtain operating data associated with at least one of an acceleration input and acoustic input from a sensor of the terminal device;
determine whether the operating data meet a preset condition; and
replace a current audio-visual effect of a user interface (UI) with a selected audio-visual effect when the operating data meet the preset conditions.

9. The apparatus of claim 8, wherein the acceleration input is generated when a user of the terminal device shakes the terminal device; and
the acoustic input is generated when the user of the terminal device blows air or speaks to a microphone of the terminal device.

10. The apparatus of claim 8, wherein when the operating data are associated with the acceleration input, the preset condition comprises, within a first preset time period, that a component of the acceleration input along a direction in a space continues to exceed a threshold value.

11. The apparatus of claim 8, wherein when the operating data are the acoustic input, the preset condition comprises at least one of:
that a peak value of the acoustic input exceeds a preset peak value for a number of times more than a first threshold value within a second preset time period; and
that a mean value of the peak value of the acoustic input exceeds a second threshold value within the second present time period.

12. The apparatus of any of claims 8 to 11, wherein to replace of the current audio-visual effect of the UI, the at least one processor is further configured to execute the at least one set of instructions to:
select an audio-visual effect of the UI from a current resource database under a preset selection mode of the terminal device; and
replace the current audio-visual effect of the UI with the selected audio-visual effect of the UI;
wherein the preset selection mode of the terminal device comprises at least one of:
a default selection mode,
a random selection mode,
a selection mode configured to select an audio-visual effect of the UI based on frequency-of-use thereof, and
a selection mode configured to select an audio-visual effect of the UI based on number-of-recommendations thereof.

13. The apparatus of claim 12, wherein the at least one processor is further configured to execute the at least one set of instructions to:
display at least one resource database,
wherein the at least one resource database comprises one or more local resource databases and Internet resource databases, and
wherein each of the one or more local databases and the Internet databases comprises a plurality of audio-visual effects of the UI;
receive a first selection signal selecting a resource database from the at least one resource database; and
determine the selected resource database as the current resource database.

14. The apparatus of any of claims 8 to 11, wherein the at least one processor is further configured to execute the at least one set of instructions to:
display a plurality of audio-visual effects from at least one resource database,
wherein the at least one resource database comprises one or more local resource databases and Internet resource databases, and
receive a second selection signal selecting the selected audio-visual effect from the plurality of audio-visual effects; and
replace the current audio-visual effect of the UI with the selected audio-visual effect after receiving the second selection signal.

15. A processor-readable non-statutory storage medium comprising at least one set of instructions for changing an audio-visual effect of a user interface on a terminal device, wherein the at least one set of instructions are configured to direct at least one processor to perform acts of:
obtaining operating data associated with at least one of an acceleration input and acoustic input from a sensor of the terminal device;
determining whether the operating data meet a preset condition; and
replacing a current audio-visual effect of a user interface (UI) with a selected audio-visual effect when the operating data meet the preset conditions.

16. The storage medium of claim 15, wherein when the operating data are associated with the acceleration input, the preset condition comprises, within a first preset time period, that a component of the acceleration input along a direction in a space continues to exceed a threshold value.

17. The storage medium of claim 15, wherein when the operating data are the acoustic input, the preset condition comprises at least one of:
that a peak value of the acoustic input exceeds a preset peak value for a number of times more than a first threshold value within a second preset time period; and
that a mean value of the peak value of the acoustic input exceeds a second threshold value within the second present time period.

18. The storage medium of any of the claims 15 to 17, wherein the replacing of the current audio-visual effect of the UI comprises:
selecting an audio-visual effect of the UI from a current resource database under a preset selection mode of the terminal device; and
replacing the current audio-visual effect of the UI with the selected audio-visual effect of the UI;
wherein the preset selection mode of the terminal device comprises at least one of:
a default selection mode,
a random selection mode,
a selection mode configured to select an audio-visual effect of the UI based on frequency-of-use thereof, and
a selection mode configured to select an audio-visual effect of the UI based on number-of-recommendations thereof.

19. The storage medium of claim 18, wherein the at least one set of instructions are further configured to direct at least one processor to perform acts of:
displaying at least one resource database,
wherein the at least one resource database comprises one or more local resource databases and Internet resource databases, and
wherein each of the one or more local databases and the Internet databases comprises a plurality of audio-visual effects of the UI;
receiving a first selection signal selecting a resource database from the at least one resource database; and
determining the selected resource database as the current resource database.

20. The storage medium of any of claims 15 to 17, wherein the at least one set of instructions are further configured to direct at least one processor to perform acts of:
displaying a plurality of audio-visual effects from at least one resource database,
wherein the at least one resource database comprises one or more local resource databases and Internet resource databases, and
receiving a second selection signal selecting the selected audio-visual effect from the plurality of audio-visual effects; and
replacing, by a processor, the current audio-visual effect of the UI with the selected audio-visual effect after receiving the second selection signal.
